(19) United States
(12) Patent Application Publication
(10) Pub. No.: US 2003/0194967 A1
(43) Pub. Date: Oct. 16, 2003

(54) Consolidated in-flight entertainment electronic system

(76) Inventors: William C. Sanford, Mukilteo, WA (US); Joseph P. Condon, Mukilteo, WA (US)

Correspondence Address: HARNESS, DICKEY & PIERCE, P.L.C., P.O. BOX 828, BLOOMFIELD HILLS, MI, 48303, US

(21) Appl. No.: 10/444,151

(22) Filed: May 22, 2003

Related U.S. Application Data
(63) Continuation-in-part of application No. 09/969,413, filed on Oct. 2, 2001.

(51) Int. Cl. H04H 7/00

(52) U.S. Cl. 455/3.06; 455/414.1

(57) ABSTRACT

A consolidated in-flight entertainment system is provided that comprises a server in communication with a controller switch that manages and distributes in-flight entertainment data to a plurality of components on a mobile platform, e.g. passenger seats on a commercial aircraft. The server receives, transmits, and stores in-flight entertainment data and further executes functional elements such as providing audio and video data, storing data, web caching and storage, and component mapping, among others, through software. Additionally, the controller switch performs certain data functions such as satellite data interfacing, multiplexing, mapping, and multimedia routing, also through software, for the efficient transfer of in-flight entertainment data to and from the server and passenger seats.

### FIELD OF THE INVENTION

The present invention relates generally to in-flight entertainment systems, and more particularly to systems that manage and distribute a variety of in-flight entertainment data to a plurality of components or passenger seats onboard a commercial aircraft.

### BACKGROUND OF THE INVENTION

An increasing number of commercial aircraft are providing in-flight entertainment systems for passengers and crew that include, for example, cabin displays for pre-flight safety information or in-flight movies, seatback telephones, audio jacks, and general video and audio data services such as e-mail, web access, and bi-directional data flow to/from passengers. The functional elements that support in-flight entertainment systems may include, by way of example, audio, video, and data storage, telephone system communications, CD (compact disc) and DVD (digital versatile/video disc) players, and pre-recorded announcement machine boarding music, among others. As a result, in-flight entertainment systems require additional systems that must be integrated onboard the commercial aircraft.

Unfortunately, current in-flight entertainment systems require a separate electronic box or LRU (line replaceable unit) for each functional element, i.e. a hardware-based solution, which results in additional volume and weight, along with increased power and cooling requirements onboard the aircraft. Additionally, the electronic boxes that perform certain functional elements are typically not “plug-and-play” compatible and must be replaced in their entirety to accommodate product upgrades. Generally, “plug-and-play” refers to easy and robust, standardized connectivity among stand-alone devices and PCs (personal computers) from many different vendors. Plug-and-play devices can be quickly coupled to a standalone PC and typically can be used with no additional hardware being needed by the PC, and with only the loading of suitable software onto the PC. Furthermore, the electronic boxes presently used often incorporate different communication protocols and are not compatible when intermixed with other electronic boxes.

The individual electronic boxes are typically located within an in-cabin purser workstation (PSW) or video control center (VCC), which houses approximately ninety (90) percent of the electronics, file servers, tape decks, CD decks, controllers, and other related elements associated with in-flight entertainment, communication, and passenger service systems. As a result, the VCC consumes revenue space that could otherwise be used for additional seats or passenger comfort features, among others, in order to provide in-flight entertainment and communication services.

Accordingly, there remains a need in the art for a consolidated in-flight entertainment system that combines the functional elements of individual electronic boxes into an integrated system that reduces the overall volume and cost of the components needed to implement an in-flight entertainment system, along with reducing power and cooling requirements. A need further exists for a consolidated in-flight entertainment system that is plug-and-play compatible and that is easily upgraded without continual replacement of individual electronic boxes. Further, a need exists for an in-flight entertainment system that is software-based rather than hardware-based to facilitate ease of upgrades and system compatibility.

### SUMMARY OF THE INVENTION

In one preferred form, the present invention provides an electronic architecture for mobile entertainment systems, e.g. in-flight entertainment systems onboard commercial aircraft, that enables a significant reduction in the number of independent components need for implementing such a system. The invention is especially well adapted for use on a commercial aircraft, although it can readily be implemented on a wide variety of mobile platforms where limited space and light weight are important considerations for any equipment used on the mobile platform. Merely, for illustrative purposes, the mobile platform will be referred to as an aircraft.

In one form, the present invention comprises a server in communication with a controller switch. The controller switch controls the transmission of mobile entertainment data, e.g. in-flight entertainment data, from the server to a plurality of passenger seats and components. Advantageously, control over the in-flight entertainment system is maintained from the server and the controller switch through software, and the server and controller switch are preferably located within the electronics equipment (EE) bay of an aircraft rather than within separate electronic boxes. Accordingly, significant additional space is made available for revenue generating seats or passenger comfort features. Further, the in-flight entertainment system is upgraded through software rather than by replacing individual electronic boxes, which would necessitate costly and time consuming rewiring within the aircraft.

Generally, the server executes a plurality of functional elements through software, wherein the functional elements comprise audio, video, and data storage, web caching and storage and distribution, and component mapping, among others. Similarly, the controller switch performs certain data functions, also through software, that comprise transmit and receive functions to and from a plurality of users so as to facilitate communications with users via touch screens or other input devices, and to facilitate video on demand, web surfing and other interactive services. The controller also facilitates various other functions such as built in test equipment dataload, satellite data interface, multiplexing, mapping, zone standard client support service interface, packet switching system data processing, multimedia routing, and avionics data standard interface, among others.

Accordingly, a consolidated in-flight entertainment system is provided that reduces the overall space requirements and cost associated with such a system, and which further reduces power and cooling requirements by eliminating power supply and other electronics onboard commercial aircraft. Further, the electronic architecture allows for plug-and-play compatibility in addition to ease of upgrades, which results in significant cost savings for an in-flight entertainment system.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram of an electronic architecture for mobile entertainment systems in accordance with the principles of the present invention.

### DETAILED DESCRIPTION OF THE PREFERRED EMBODIMENT

The following description of the preferred embodiments is merely exemplary in nature and is in no way intended to limit the invention, its application, or uses.

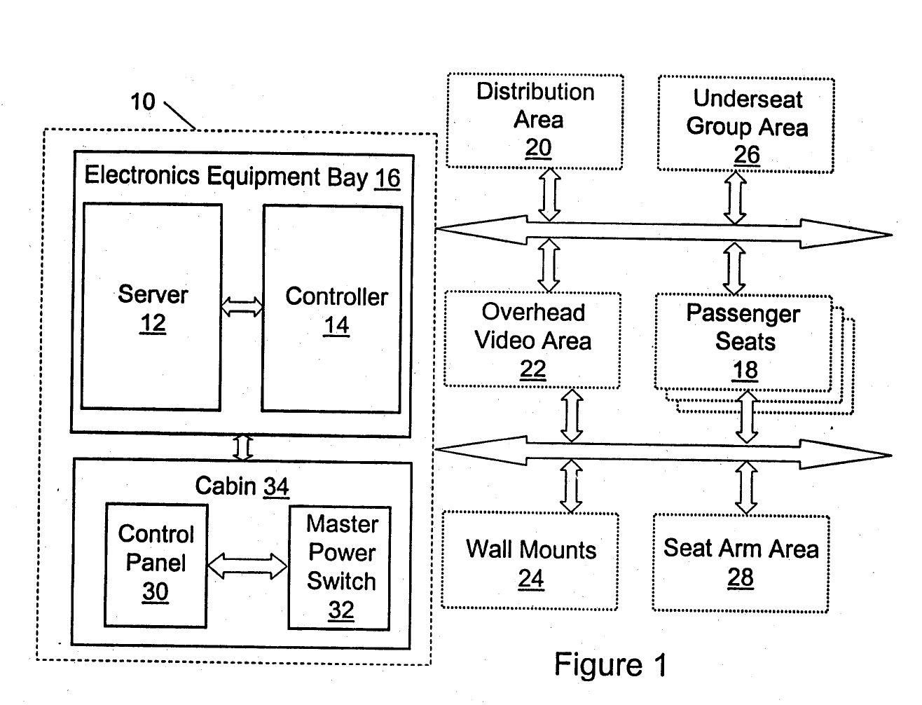

Referring to the drawings, one preferred embodiment of an electronic entertainment system 10 is illustrated in FIG. 1. As shown, the system 10 comprises a server 12 in communication with a controller switch 14, which are both preferably located within an electronics equipment bay 16 of a mobile platform such as an aircraft, and controlled by a control panel 30 and master power switch 32 in a cabin environment 34. Generally, the server 12 stores in-flight entertainment data, receives requests for in-flight entertainment data, and routes in-flight entertainment data through the controller switch 14 to a component such as a plurality of passenger seats 18. Further, the controller switch 14 controls the transmission of in-flight entertainment data to the plurality of passenger seats 18, preferably as a part of an in-seat area, and also to other components of the system 10 as described in greater detail below.

Although the system 10 as described herein is directed to an in-flight entertainment system for delivering in-flight entertainment data to passenger seats and other components on a commercial aircraft, the invention is also applicable to other modes of mass transit such as ship, train, bus, and others, and the reference to aircraft should not be construed as limiting the scope of the present invention. Accordingly, the term “in-flight entertainment” is also referred to as mobile entertainment to encompass other modes of transportation to which the present invention may be applied.

The controller switch 14 is a processor that is commonly used in network applications, wherein the controller switch 14 receives requests for data from the passenger seats 18 in one form of the present invention. Upon receipt of the request(s), the controller switch 14 transmits the data request and a unique IP address for each passenger seat 18, as part of a packet, to the server 12. The server 12 then retrieves the requested data and transmits the data back to the passenger seat 18 using the unique IP address for each passenger seat 18. The use of passenger seats 18 is merely exemplary to illustrate data flow and operation of the controller switch 14 and the server 12. Accordingly, other components of the system 10, which are described in greater detail below, may also request and receive data from the controller switch 14 and the server 12.

As further illustrated, the system 10 further communicates with other components such as an overhead/underfloor distribution area 20, an overhead video area 22, wall mounts or monuments 24 (e.g., telephones, monitors), an underseat group area 26, and a seat arm area 28. The overhead/underfloor distribution area 20 generally functions to distribute seat power, seat wireless or fiber optic interfaces, panel wireless or fiber optic interfaces, and wall mount or monument interfaces. Further, the underseat group area 26 also provides power distribution. The overhead video area 22 generally comprises tapping units, video display units such as a CRT (cathode ray tube), LCD (liquid crystal display) displays, and other forms of large displays. Additionally, the seat arm area 28 comprises interfaces for headphones, telephones, PC power, and volume/channel selection controls, among others. Preferably, the passenger seats 18 each comprise an LCD screen or a touch screen or other input/output device, a multimedia decoding subsystem, a seat multiplexing subsystem, a default data storage device, and optionally wireless receive and transmit provisions subsystems, among others.

A variety of additional components of an in-flight entertainment system may also be provided that communicate with the system 10 of the present invention. Accordingly, such components as described above are merely exemplary of typical locations onboard an aircraft where data is delivered based on a request from a user or another aircraft system. For example, with a seat arm area 18, a passenger may connect a set of headphones to the seat arm area 18 to listen to audio data such as music or boarding announcements. As the passenger changes channels on the seat arm area 18, the request for audio and data to that channel and the IP address for the particular seat arm area 28 is transmitted to the controller switch 14. The controller switch 14 transmits the audio request and a unique IP address for the seat arm area 28, as part of a packet, to the server 12. The server 12 then retrieves the requested audio data and transmits the data back to the seat arm area 28 using the unique IP address for the seat arm area 28. Accordingly, the in-flight entertainment system 10 components as described herein are merely exemplary and shall not be construed as limiting the scope of the present invention.

The server 12 executes various functions through software that include, for example, audio, video, and data storage, web caching and storage, and component mapping, among others. As commonly known in the art, the server 12 comprises three core elements, namely, a processor (which may comprise multiple processors), a router (which similarly may comprise multiple processors), and one or more data storage subsystems. As an example, when a passenger requests data or information, the request is transmitted to the server 12 through the controller switch 14 as previously described. The server 12 processes the request and retrieves the requested data from the data storage subsystem within the server. The data is then routed back to the passenger and displayed or presented to the passenger seat 18 or to the seat arm area 28 as previously described. Similarly, a request from the control panel 30 may be made to generate a request, signal or command to transmit video data to the overhead video area 22, and the server 12 processes the request, signal or command and retrieves the video data from data storage and routes the video data to the overhead video area 22.

The functions of the server 12 preferably comprise, by way of example, audio and video data storage, web caching and storage, seat and/or area mapping (i.e., managing data flow between specific, predetermined areas within an aircraft or to/from data ports at specific seat locations), and telephone system communications. Functions of the controller 14 preferably comprise, by way of example, transmit (TX) and receive (RX) to a seat or area, built-in test equipment (BITE) and dataload, interfacing with satellite data, multiplexing and mapping, zone standard cell site selection (CSS) interface (I/F), packet switch stream (PSS) data processing, multimedia routing, and standard avionics data interfaces (i.e., interfaces with the flight computer for data such as aircraft position or meteorological conditions), among others.

The control panel 30 is a crew control point and is preferably an LCD screen or other form of display, used in connection with a keyboard and/or mouse input, wherein a crew member selects data functions from a layered menu presented on the display. For example, the crew member may select boarding music when the aircraft is on the ground, pre-recorded safety announcements when the aircraft is taxiing, and video and audio data while the aircraft is airborne. Alternately, the control panel 30 may comprise other types of input devices such as a touch screen, CRT (cathode ray tube), or a keypad, among others, while remaining within the scope of the present invention.

Furthermore, the in-flight entertainment data is preferably distributed via a wireless interface to the passenger seats 18 and to other components of the in-flight entertainment system. For example, the wireless standard IEEE 802.11a may provide the required bandwidth to support graphics and the needed communication interfaces data rates. However, other methods commonly known in the arts such as hardwiring or optical fibers, among others, may also be employed to transmit in-flight entertainment data in accordance with the teachings of the present invention.

The server 12 is located within the electronics equipment bay 16, or a crown area, rather than within purser work stations or video control centers as is typically the case with present day aircraft. Further, the server 12 replaces and essentially performs the functions of numerous, independent electronic boxes (LRUs) as previously described, thereby creating more space for additional seats or passenger comfort features. Additionally, using the server 12 to perform various functions through software, rather than with individual electronic boxes (i.e., hardware), results in significant cost and weight savings, in addition to reduced power and cooling requirements. Moreover, the system 10 is easily upgradeable through its software and is further plug-and-play compatible.

The controller switch 14 is also preferably located within the electronics equipment bay 16 along with the server 12 and similarly executes data functions through software. The data functions may include, for example, transmit and receive to and from a plurality of users, built in test equipment dataload, satellite data interface, multiplexing, mapping, zone standard client support service interface, packet switching system data processing, multimedia routing, and avionics data standard interface, among others. Therefore, the controller switch 14 controls the transmission of in-flight entertainment data to the plurality of passenger seats 18 and to other components of the in-flight entertainment system.

Accordingly, the electronic system 10 of the present invention provides a consolidated, in-flight entertainment system that requires less space and cost than previously implemented in-flight entertainment systems. The system 10 further reduces power and cooling requirements onboard commercial aircraft by replacing numerous, independent electronic boxes and related hardware with a single server 12 and suitable software. Further, the electronic system 10 allows for plug-and-play compatibility in addition to ease of upgrades, which results in significant cost savings for an in-flight entertainment system.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An electronic system adapted for use on a mobile platform for providing data to at least one component on the mobile platform, the electronic system comprising:
a server that receives, transmits, and stores mobile entertainment data; and
a controller switch in communication with the server that controls the transmission of mobile entertainment data to a plurality of components,
wherein a plurality of functional elements are executed by the server and data functions are executed by the controller switch through software.

2. The electronic entertainment system of claim 1, wherein the mobile platform is an aircraft and the server is located in an electronics equipment bay of the aircraft.

3. The electronic entertainment system of claim 1, wherein the functional elements further comprise audio, video, and data storage.

4. The electronic entertainment system of claim 1, wherein the functional elements further comprise web caching and storage.

5. The electronic entertainment system of claim 1, wherein the functional elements further comprise component mapping.

6. The electronic entertainment system of claim 1, wherein the functional elements further comprise telephone system communications.

7. The electronic entertainment system of claim 1, wherein the controller switch performs data functions selected from a group consisting of transmit and receive to and from a plurality of components, built in test equipment dataload, satellite data interface, multiplexing, mapping, zone standard client support service interface, packet switching system data processing, multimedia routing, or avionics data standard interface.

8. The electronic entertainment system of claim 1, wherein the components further comprise passenger seats.

9. The electronic entertainment system of claim 1, wherein the transmission of mobile entertainment data is wireless.

10. The electronic entertainment system of claim 1, wherein the mobile entertainment data is in-flight entertainment data.

11. A method of managing mobile entertainment data, the method comprising the steps of:
(a) receiving, transmitting, and storing mobile entertainment data on a server that executes functional elements within an electronics equipment bay of a mobile platform;
(b) establishing communication between the server and a controller switch that that controls the transmission of mobile entertainment data to a plurality of passenger seats on a mobile platform;
(d) distributing mobile entertainment data to and from the controller switch to and from the plurality of passenger seats.

12. The method of claim 11, wherein the mobile platform is an aircraft.

13. The method of claim 11, wherein the functional elements are selected from a group consisting of audio, video, and data storage, web caching and storage, and component mapping.

14. The method of claim 11, wherein the controller switch performs functions selected from a group consisting of transmit and receive to and from a plurality of users, built in test equipment dataload, satellite data interface, multiplexing, mapping, zone standard client support service interface, packet switching system data processing, multimedia routing, or avionics data standard interface.

15. The method of claim 11, wherein the distribution of mobile entertainment data is wireless.

16. The method of claim 11, wherein the mobile entertainment data is in-flight entertainment data.

17. An electronic entertainment system comprising:
a server located within an electronics equipment bay of an aircraft that receives, transmits, and stores in-flight entertainment data; and
a controller switch in communication with the server that controls the transmission of in-flight entertainment data to a plurality of passenger seats in the aircraft,
wherein a plurality of functional elements are executed by the server and data functions are executed by the controller switch through software.

19. The electronic entertainment system of claim 17, wherein the transmission of in-flight entertainment data is wireless.
